(19) United States
(12) Patent Application Publication
(10) Pub. No.: US 2025/0270871 A1
(43) Pub. Date: Aug. 28, 2025

(54) FENESTRATION UNIT WITH INTERIOR-TO-EXTERIOR INSTALLATION FEATURES AND ASSOCIATED SYSTEMS AND METHODS

(71) Applicant: Pella Corporation, Pella, IA (US)

(72) Inventors: Jaime P. Ogbourne, Knoxville, IA (US); Evan R. Vande Haar, Pella, IA (US)

(73) Assignee: Pella Corporation, Pella, IA (US)

(21) Appl. No.: 19/057,853

(22) Filed: Feb. 19, 2025

Related U.S. Application Data
(60) Provisional application No. 63/557,028, filed on Feb. 23, 2024.

(51) Int. Cl. E06B 1/36; E06B 1/60

(52) U.S. Cl. CPC E06B 1/36; E06B 1/6069; E06B 1/6084

(57) ABSTRACT

Installation systems and methods for fenestration units configured to be set into a rough opening from an exterior side of a building structure or wall. The fenestration units may include a retention system coupled to the frame and operable to exert a retention force on the fenestration unit to maintain positive engagement of the fenestration unit with the rough opening framing and resist extraction of the fenestration unit from the rough opening upon insertion of the fenestration unit in the rough opening from the exterior side of the rough opening.

### CROSS-REFERENCE TO RELATED APPLICATION

This application claims priority to U.S. Provisional Patent Application No. 63/557,028, entitled “FENESTRATION UNIT WITH INTERIOR-TO-EXTERIOR INSTALLATION FEATURES AND ASSOCIATED SYSTEMS AND METHODS”, filed Feb. 23, 2024, the disclosure of which is hereby incorporated by reference in its entirety.

### BACKGROUND

Window designs typically have an exterior nailing flange and are installed from the exterior side of the building envelope. Two installers work together, one on the interior and the other on the exterior. Some installation crews have determined it is easier to unpackage the window inside the building where it is relatively clean and flat. Then they pass the window through the rough opening to a person on the exterior side. In some instances, the person on the exterior side is on a ladder which can substantially complicate installation. The installer on the interior side centers the window in the RO and inserts shims to level, plumb and square all while the exterior installer is holding the window. After the window is correctly set, the interior installer holds the window in place while the exterior installer drives nails or screws through the exterior nailing flange to anchor it. If it is a venting window, the sash is then opened to check functional operation. The exterior installer typically then applies 3 to 4 inches wide flashing tape on the jambs and across the head of the window. The interior installer may then proceed to inject expansion foam around the perimeter of the window in the gap between the frame and rough opening framing to create the interior air seal.

Background Patents

| Patent Number | Title | Filing Date |
|---|---|---|
| U.S. 8,621,795 | Fenestration frame with bonded | 2011 Apr. 20 |
| | support brackets . . . | |
| U.S. 8,109,052 | Monolithic fenestration | 2009 May 21 |
| | construction member . . . | |
| U.S. 7,162,841 | Spring clip and method of window | 2004 Feb. 13 |
| | installation | |
| DE 2020 16101375 | Supporting and fastening | 2016 Mar. 11 |
| | window . . . to . . . wall opening | |
| WO 2015/142201 | Mounting, sealing and thermal | 2014 Sep. 5 |
| | insulation of windows . . . | |
| U.S. 6,293,061 | System and method for installing a | 1999 Sep. 30 |
| | jamb | |
| U.S. 5,692,350 | Apparatus and method for leveling | 1996 Feb. 2 |
| | closures | |
| U.S. 11,332,946 | Installation features for fenestration | 2019 Jul. 25 |
| | units . . . | |
| U.S. 8,006,445 | Self-sealing window installation | 2008 Jan. 15 |
| | and method | |
| U.S. 2008/0127564 | Pre-hung door assembly and | 2008 Jan. 18 |
| | method of installation | |
| U.S. 10,895,099 | Support bracket for window | 2016 Aug. 23 |
| | installation . . . | |
| U.S. 2005/0262782 | Self-Flashing Assembly | 2004 Jun. 1 |
| U.S. 2020/0318418 | Fenestration assembly and | 2020 Apr. 2 |
| | installation system for the same | |
| U.S. 4,488,391 | Centering clips for window frames | 1980 Dec. 17 |
| U.S. 2011/0258947 | Fenestration frame with bonded | 2011 Apr. 20 |
| | support brackets and methods of | |
| | making same | |

### BACKGROUND PRODUCTS

### Innotech Windows & Doors, Strap Anchors

https://www.innotech-windows.com/blog/in-depth-benefits-of-anchoring-method-window-installation

### FrontLine Tru-Loc™ Brackets

https://frontlinebldg.com/all-products/accessories/tru-loc-window-door-installation-anchor/Amesbury

### Hinged Fin

https://www.amesburytruth.com/products/extrusions/nailing-fin/hinged/hinged-pp1219

### SUMMARY

Various advantages may be achieved according to the example systems and methods described herein. The various example advantages may be one or more of: more efficient (e.g., cycle time reduced by 50% or more); easier to learn; easier to remember; easier to train; can be installed by a single person; interior and exterior installation tasks do not need to be done simultaneously; delivers an installation method that is unique to the industry and offers many benefits for the installer; faster cycle times; adapts to wall depth variation; separates interior and exterior work so they can be done “independently”.

### Interior-to-Exterior Installation System—Device

According to one embodiment (“Embodiment 1”), a fenestration unit is configured for installation in a rough opening in a structure defined by rough opening framing, the rough opening having an interior side and an exterior side and the rough opening framing having an interior face and an exterior face opposite the interior face. The fenestration unit includes a frame configured to be moved through the rough opening from the interior side to the exterior side, and the frame includes a perimeter. An installation fin is coupled to the frame and projects outward relative to the perimeter of the frame. The installation fin is configured to abut an exterior surface of the structure surrounding the rough opening upon moving the frame from the exterior side back toward the interior side of the rough opening. A retention system is coupled to the frame and operable to exert a retention force on the rough opening framing to maintain positive engagement of the fenestration unit with the rough opening framing and resist extraction of the fenestration unit from the rough opening upon moving the frame from the exterior side back toward the interior side of the rough opening such that the fenestration unit remains stationary in the rough opening.

According to another embodiment (“Embodiment 2”), further to Embodiment 1, the retention system includes a retainer coupled to the frame, and the retainer includes a plurality of arms configured to contact the rough opening framing to maintain positive engagement of the fenestration unit with the rough opening framing and resist extraction of the fenestration unit from the rough opening.

According to another embodiment (“Embodiment 3”), further to one of Embodiments 1-2, the plurality of arms includes a first arm, a second arm, and a third arm.

According to another embodiment (“Embodiment 4”), further to one of Embodiments 1-3, the plurality of arms includes a first arm having a first length and a second arm having a second length, the second length being less than the first length.

According to another embodiment (“Embodiment 5”), further to one of Embodiments 1-4, each arm of the plurality of arms includes an engagement feature at a terminal end.

According to another embodiment (“Embodiment 6”), further to one of Embodiments 1-5, the retention system includes a retainer, the retainer including a plurality of feet configured to couple the retainer to the frame.

According to another embodiment (“Embodiment 7”), further to one of Embodiments 1-6, the plurality of feet are received in slots formed in the frame to couple the retainer to the frame.

According to another embodiment (“Embodiment 8”), further to one of Embodiments 1-7, the slots are formed in sidewalls of a channel formed on the perimeter of the frame.

According to another embodiment (“Embodiment 9”), further to one of Embodiments 1-8, at least one foot of the plurality of feet includes an ankle portion coupled to an angled toe portion.

According to another embodiment (“Embodiment 10”), further to one of Embodiments 1-9, the frame further includes a bottom, and further including a sill spacer coupled to the bottom of the frame and configured abut the rough opening framing.

According to another embodiment (“Embodiment 11”), further to one of Embodiments 1-10, further including a strap configured to receive a fastener for securing the fenestration unit to the rough opening framing.

### Interior-to-Exterior Installation System—Method of Installation

According to one embodiment (“Embodiment 1”), a method of installing a fenestration unit in a rough opening in a structure defined by rough opening framing, the rough opening having an interior side and an exterior side, and the method includes: moving the fenestration unit through the rough opening from the interior side to the exterior side; and after moving the fenestration unit through the rough opening, moving the fenestration unit from the exterior side toward the interior side to seat a frame of the fenestration unit in the rough opening such that a retention system coupled to the frame of the fenestration unit exerts a retention force on the rough opening framing to retain the frame in the rough opening and inhibit tipping of the frame toward the exterior side of the rough opening.

According to another embodiment (“Embodiment 2”), further to Embodiment 1, the retention system includes a retainer coupled to the frame, the retainer including a plurality of arms, and wherein the plurality of arms exert the retention force on the rough opening framing to retain the frame in the rough opening and inhibit tipping of the frame toward the exterior side of the rough opening.

According to another embodiment (“Embodiment 3”), further to one of Embodiments 1-2, the plurality of arms includes a first arm, a second arm, and a third arm.

According to another embodiment (“Embodiment 4”), further to one of Embodiments 1-3, the plurality of arms includes a first arm having a first length and a second arm having a second length, the second length being less than the first length.

According to another embodiment (“Embodiment 5”), further to one of Embodiments 1-4, each arm of the plurality of arms includes an engagement feature at a terminal end.

According to another embodiment (“Embodiment 6”), further to one of Embodiments 1-5, the retention system includes a retainer, the retainer including a plurality of feet coupling the retainer to the frame.

According to another embodiment (“Embodiment 7”), further to one of Embodiments 1-6, the plurality of feet are positioned in slots formed in the frame to couple the retainer to the frame.

According to another embodiment (“Embodiment 8”), further to one of Embodiments 1-7, the slots are formed in sidewalls of a channel formed on a perimeter of the frame.

According to another embodiment (“Embodiment 9”), further to one of Embodiments 1-8, at least one foot of the plurality of feet includes an ankle portion coupled to an angled toe portion.

According to another embodiment (“Embodiment 10”), further to one of Embodiments 1-9, further including, after moving the fenestration unit from the exterior side toward the interior side to seat the frame in the rough opening, securing the fenestration unit to the rough opening framing by installing a fastener through an installation fin coupled to the frame.

According to another embodiment (“Embodiment 11”), further to one of Embodiments 1-10, further including, after moving the fenestration unit from the exterior side toward the interior side to seat the frame in the rough opening, securing the fenestration unit to the rough opening framing by installing a fastener through a strap coupled to the frame.

According to another embodiment (“Embodiment 12”), further to one of Embodiments 1-11, further including hoisting the fenestration unit relative to the rough opening by using a hoisting system.

According to another embodiment (“Embodiment 13”), further to one of Embodiments 1-12, the hoisting system includes a rope and a pulley system.

According to another embodiment (“Embodiment 14”), further to one of Embodiments 1-13, further including, after hoisting the fenestration unit relative to the rough opening by using the hoisting system, positioning a cross beam between the rope and the rough opening framing.

According to another embodiment (“Embodiment 15”), further to one of Embodiments 1-14, further including, before moving the fenestration unit through the rough opening from the interior side to the exterior side, hoisting the fenestration unit relative to the rough opening by using a hoisting system.

According to another embodiment (“Embodiment 16”), further to one of Embodiments 1-15, moving the fenestration unit from the exterior side toward the interior side to seat the frame in the rough opening further includes abutting a sill spacer coupled to a bottom of the frame against the rough opening framing.

The foregoing embodiments and additional embodiments described herein should not be read to limit or otherwise narrow the scope of any of the inventive concepts otherwise provided by the instant disclosure. While multiple examples are disclosed, still other embodiments will become apparent to those skilled in the art from this specification and its drawings, which show and describe various illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a top perspective view of a fenestration unit and rough opening framing from an interior side, according to some embodiments.

FIG. 2 is a bottom perspective view of the fenestration unit of FIG. 1 from the interior side, according to some embodiments.

FIG. 3 is a detail perspective view of the features of the fenestration unit within line 3-3 of FIG. 1, including a retainer, according to some embodiments.

FIG. 4 is a sectional view of the fenestration unit along line 4-4 of FIG. 3, according to some embodiments.

FIG. 5 is a top-oriented perspective view of the retainer of FIG. 3, according to some embodiments.

FIG. 6 is a bottom-oriented perspective view of the retainer of FIG. 3, according to some embodiments.

FIG. 7 is a detail perspective view of the features of the fenestration unit within line 7-7 of FIG. 2, including sill spacers and a tether system, according to some embodiments.

FIG. 8 is a detail perspective view of the features of the fenestration unit within line 8-8 of FIG. 7, including one of the sill spacers, according to some embodiments.

FIG. 9 is a side-oriented, perspective view of the fenestration unit and the rough opening framing of FIG. 1 from the interior side with the fenestration unit being passed through the rough opening to the exterior side of the rough opening framing, according to some embodiments.

FIG. 10 is a side-oriented, perspective view of the fenestration unit and the rough opening framing of FIG. 1 from the interior side with the fenestration unit seated in the rough opening, according to some embodiments.

FIG. 11 is a side-oriented, perspective view of the fenestration unit and the rough opening framing of FIG. 1 from an exterior side with the fenestration unit seated in the rough opening, according to some embodiments.

FIG. 12 is a side-oriented, perspective view of another fenestration unit, rough opening framing, and a hoisting assembly from an interior side, according to some embodiments.

FIG. 13 is a side-oriented, perspective view of the fenestration unit of FIG. 12, the rough opening framing of FIG. 12, the hoisting assembly of FIG. 12 and a securing cross beam from the interior side, according to some embodiments.

FIG. 14 is a top-oriented perspective view of a retainer for a fenestration unit, according to some embodiments.

FIG. 15 is a bottom-oriented perspective view of the retainer of FIG. 14, according to some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale and may be exaggerated to illustrate various aspects of the present disclosure, and in that regard, the drawing figures should not be construed as limiting.

### DESCRIPTION OF VARIOUS EMBODIMENTS

Various concepts of this patent specification address installation systems and methods for fenestration units, such as windows and doors. Some features of such systems and methods include one or more of the following: configured to be efficiently set into a rough opening of a building structure or wall using an interior-to-exterior installation method; pre-applied sill spacers (e.g., factory-applied); pre-applied head stabilizers and/or jamb stabilizers for self-stabilization in the rough opening while leveling, plumbing, squaring, and/or anchoring the fenestration unit; configured to be installed by a single person/installer; interior and exterior installation tasks can be performed at different times.

In various examples, the fenestration units (e.g., fenestration unit 100) include features that promote efficient installation of the fenestration unit in a rough opening using a methodology that can be readily achieved by a single installer. Additionally or alternatively, the fenestration units may include features that facilitate separation of interior and exterior installation activities, regardless of the number of installers. For instance, a fenestration unit according to various examples includes a retention system coupled to the frame of the fenestration unit that is operable to exert a retention force on the fenestration unit to maintain positive engagement of the fenestration unit with the rough opening framing and resist extraction of the fenestration unit from the rough opening upon insertion of the fenestration unit in the rough opening.

In this manner, a single individual may insert a fenestration unit into a rough opening, without needing a second person to hold the fenestration unit against the rough opening framing, or otherwise assist with maintaining the positioning of the fenestration unit in the rough opening. This retention feature also removes the need for the installer to use one hand to hold the fenestration unit against the rough opening framing, freeing both hands of the installer to carry out the installation process, such as securing the fenestration unit to the rough opening using fasteners, such as nails or screws, and/or leveling, plumbing, and squaring the fenestration unit within the rough opening.

### Fenestration Unit 100

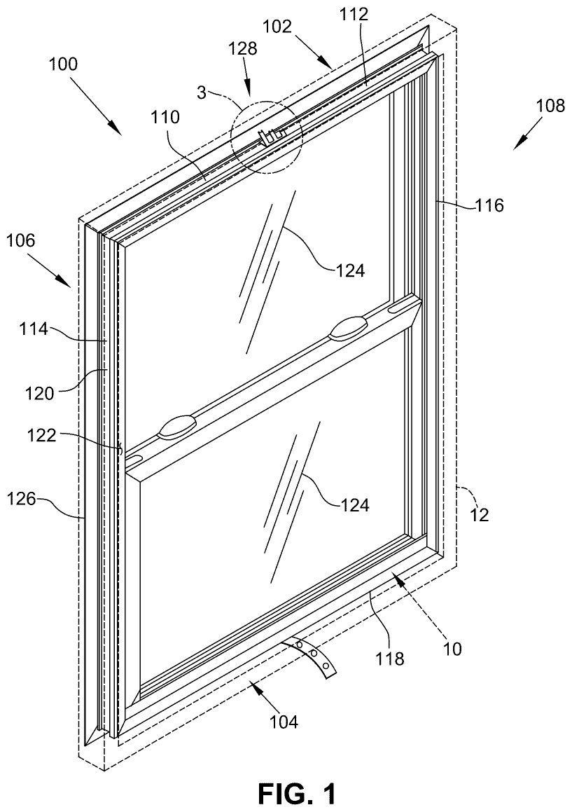

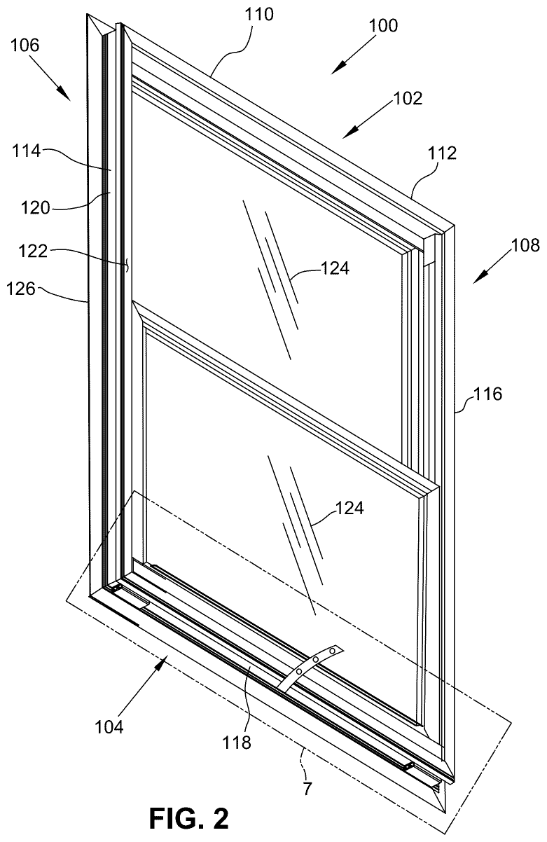

FIGS. 1 and 2 illustrate a fenestration unit 100, according to some embodiments, where FIG. 1 is a top view from an interior side of a building or wall and FIG. 2 is a bottom view from the interior side of the building or wall. The fenestration unit 100 includes features that facilitate installing the unit 100 in a rough opening 10 of the building or wall (illustrated in phantom lines in FIG. 1) using an efficient interior-to-exterior method (and in some cases, with a single installer). Generally, the interior-to-exterior installation method includes unpackaging the unit 100 on a first or interior side of the rough opening 10, passing the unit 100 through the rough opening 10 to a second or exterior side of the rough opening 10, and then seating the unit 100 in the rough opening 10 by moving the unit 100 back toward the interior side of the rough opening 10. These aspects are described in further detail below.

The fenestration unit 100 is illustrated in an installing configuration, or installation configuration, in which the unit 100 is configured for positioning in the rough opening 10, which is defined by rough opening framing 12 (also illustrated in phantom lines in FIG. 1). As described in further detail below, the fenestration unit 100 is also configurable in an initial, stowed, or pre-installation configuration (e.g., as initially received by an installer).

With continued reference to FIGS. 1 and 2, the fenestration unit 100 generally includes a top 102, a bottom 104, a first side 106, and a second side 108. The fenestration unit 100 includes a frame 110 including a head 112, a first jamb 114, a second jamb 116, and a sill 118. These components of the frame 110 together define an outer perimeter 120, a front or interior face 122, as well as a back or exterior face (not shown). The frame 110 may be constructed of vinyl, fiberglass, wood, or other materials.

The fenestration unit 100 also includes one or more panel units or glazing units 124 supported by the frame 110. Each glazing unit 124 may be any of a variety of configurations, but in some embodiments is an insulated glass (IG) unit. As shown, the fenestration unit 100 is configured as a double hung window, but any of a variety of configurations (fixed, single hung, casement, awning or other) are also contemplated.

The fenestration unit 100 further includes an installation flange system 126, also described as an installation fin, that extends outward from the perimeter 120 of the frame 110. The installation flange system 126 is configured to abut the exterior surface of the structure surrounding the rough opening 10 and act as an exterior water barrier. The installation flange system 126 is also configured to receive fasteners (not shown), such as nails or screws, to secure the unit 100 to the rough opening framing 12. The installation flange system 126 may be covered by flashing tape (not shown) or other treatments to seal the fenestration unit 100 to the exterior face of the rough opening framing 12.

With continued reference to FIGS. 1 and 2, the fenestration unit 100 includes one or more installation features that facilitate installation of the fenestration unit 100 in the rough opening 10. For example, the fenestration unit 100 may include a retention system having an installation stabilizer system 128, a sill spacer system 130, and a tether system 132. These features are described in further detail below.

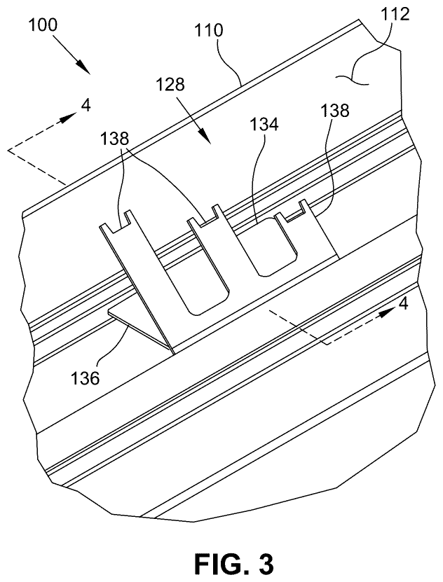

With reference to FIGS. 3-6, the installation stabilizer system 128 includes one or more retainers 134, also described as stabilizer clips. In some embodiments and as illustrated, the installation stabilizer system 128 includes one retainer 134. In some embodiments, the retainer 134 may be detached from the frame 110 in the pre-installation configuration. In other embodiments, the retainer 134 may be coupled to the frame 110 in the pre-installation configuration. In some embodiments and as illustrated, the retainer 134 is positioned on the head 112 of the frame 110. In some embodiments, the retainer 134 is positioned on the sill 118 of the frame 110 or one of the jambs 114, 116, or one or more additional retainers 134 are positioned on the sill 118 or one or more of the jambs 114, 116. The retainer 134 may be fabricated by sheet metal stamping and bending processes.

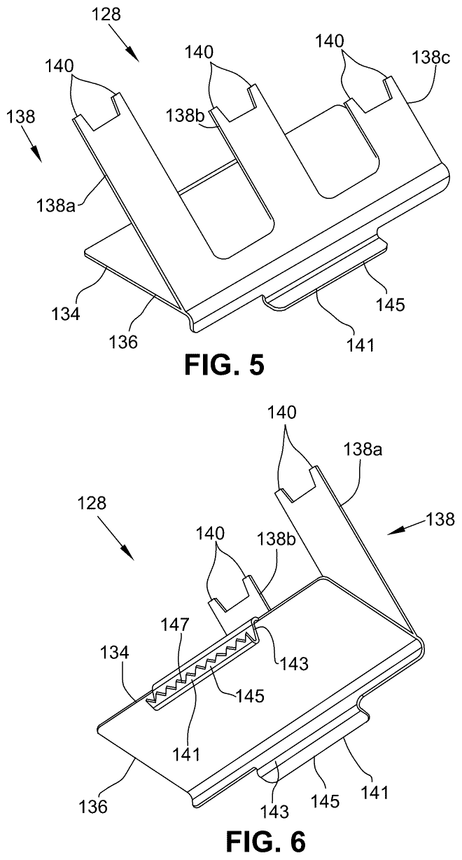

Generally, the retainer 134 is configured to permit insertion of the frame 110 within the rough opening 10 in a first insertion direction (for example and as described in further detail below, from the exterior side of rough opening 10 toward the interior side) and resist extraction of the frame 110 from the rough opening 10 in an extraction direction (for example and as described in further detail below, from the interior side of the rough opening 10 toward the exterior side). The retainer 134 includes a base 136 configured to be secured to the frame 110, and one or more flex arms 138 extending from the base 136. As shown in FIGS. 5 and 6, each flex arm 138 includes one or more engagement features 140 at a terminal end. In some embodiments and as illustrated, the engagement features 140 are generally rectangular teeth-like structures that are configured to “bite” into the rough opening framing. In some embodiments and as illustrated, one or more of the flex arms 138 may have a different length than other flex arms 138. For example and as illustrated in FIGS. 5 and 6, the retainer 134 includes a first flex arm 138a, a second flex arm 138b, and a third flex arm 138c on the opposite side of the second flex arm 138b than the first flex arm 138a. In some embodiments and as illustrated, the first flex arm 138a has a first length, the second flex arm 138b has a second length less than the first length, and the third flex arm 138c has a third length less than the second length. In some embodiments, the different lengths of the flex arms 138 advantageously permit the fenestration unit 100 to be installed in rough openings of various sizes, in particular rough openings that provide different gap sizes between the head 112 of the frame 110 and the rough opening framing. In some embodiments, all of the flex arms 138 may have the same length. In some embodiments and as illustrated, the flex arms 138a, 138b, and 138c extend from the base 136 at the same angle. In some embodiments, the flex arms 138a, 138b, and 138c extend from the base 136 different angles, or are otherwise structured to provide the flex arms 138a, 138b, and 138c with different heights relative to the base 136. Stated another way, in some embodiments the first flex arm 138a has a first height relative to the base 136, the second flex arm 138b has a second height relative to the base 136 less than the first height, and the third flex arm 138c has a third height relative to the base 136 less than the second height.

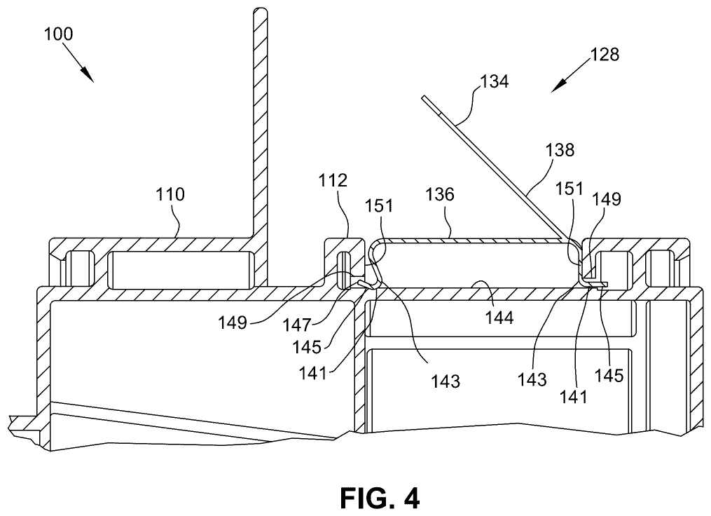

With reference again to FIGS. 4-6, in some embodiments the base 136 includes one or more coupling feet 141 for coupling the base 136 to the frame 110. In some embodiments and as illustrated, one or more of the coupling feet 141 include an ankle portion 143 coupled to the base 136 and an angled toe portion 145 coupled to the ankle portion 143 opposite the base 136. In certain embodiments and as illustrated, one or more of the coupling feet 141 further include one or more claws 147, that may collectively form a serrated edge-like structure, extending from the angled toe portions 145. In some embodiments and as illustrated, the toe portion 145 and the claws 147 project at an acute angle from the ankle portion 143. In some embodiments and as illustrated specifically in FIG. 4, the coupling feet 141 couple the retainer 134 to the frame 110 by being received in slots 149 formed in sidewalls 151 of a channel 144 formed on the perimeter 120 on the frame 110. More specifically, the angled toe portions 145 of the feet 141 are received in the slots 149 formed in the sidewalls 151 of the channel 144. The feet 141 may alternatively take the form of any of those described in the US application filed concurrently herewith, identified by docket no. 426998.001053, first listed inventor Jake Baier, and entitled FENESTRATION UNIT WITH INTERIOR INSTALLATION FEATURES AND ASSOCIATED SYSTEMS AND METHODS, the disclosure of which is hereby incorporated by reference for all purposes. In some embodiments, the retainer 134 may be coupled to the frame 110 in additional or alternative manners, such as via adhesion or fasteners.

During insertion of the frame 110 in the insertion direction, one or more of the flex arms 138 of the retainer 134 (e.g., the longest flex arm 138 if a large gap is present between the frame 110 and the rough opening framing 12 or all of the flex arms 138 if a small gap is present) bends or is deflected in a first flex direction. The insertion force, or force required to move the unit 100 in the insertion direction may be, for example, 1 lb. or less, more than 1 lb, more than 10 lbs, or more than 15 lbs. Upon application of a force on the frame 110 in the extraction direction, the flex arm 138 bends in a second flex direction to resist movement of the frame 110 in the second direction (e.g., toward the exterior side). The extraction or tipping force, or force required to move the unit 100 in the second direction after seating may be greater than the insertion force. The extraction force may be, for example, 1 lb or less, more than 1 lb, 10 lbs or more, at least 15 lbs, or 15 lbs or more. In some examples, the extraction force is 80 lbs or more, or approximately 88 lbs. Generally, a higher extraction or tipping force (e.g., as compared to the insertion force) helps ensure the fenestration unit 100 remains in place after being inserted into the rough opening 10 to permit subsequent levelling and/or securement procedures.

Further aspects of the installation stabilizer system 128 and the retainer(s) 134 may be as described in U.S. application Ser. No. 18/478,189, filed Sep. 29, 2023, the disclosure of which is hereby incorporated by reference for all purposes.

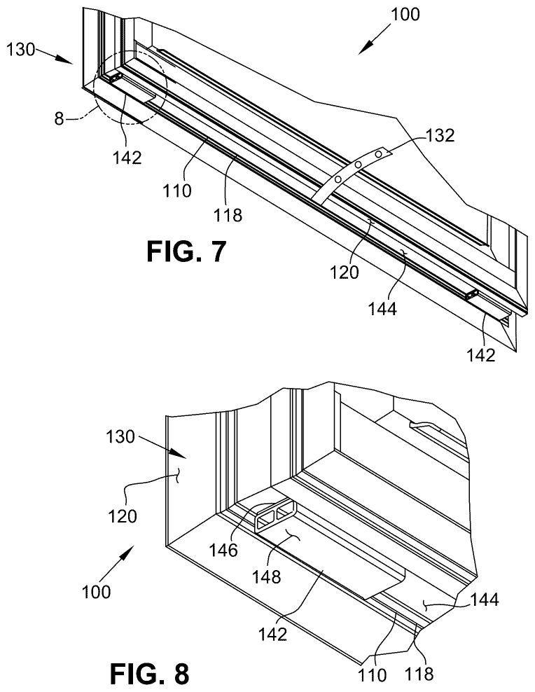

Referring to FIGS. 7 and 8, the sill spacer system 130 includes one or more sill spacers 142, such as a pair of sill spacers 142 (both spacers 142 being illustrated in FIG. 7, one spacer 142 being illustrated in FIG. 8), attached to the bottom of the frame 110 at the sill 118. In some embodiments, the sill spacers 142 may be detached from the frame 110 in the pre-installation configuration. In other embodiments, the sill spacers 142 may be coupled to the frame 110 in the pre-installation configuration.

In some embodiments, the sill spacer system 130 provides a convenient mechanism for positioning and leveling the fenestration unit 100 inside the rough opening 10 (shown elsewhere). In some embodiments, the sill spacer system 130 facilitates centering the fenestration unit 100 within the rough opening 10 by reducing friction between the frame 110 of the fenestration unit 100 and the rough opening 10 as they move against each other. The sill spacer system 130 establishes a gap between the rough opening 10 and the sill 118 to make it easier for an installer to adjust the position of the fenestration unit 100 (e.g., insert a pry bar or other tool under the sill 118 of the fenestration unit 100 for lifting and leveling). Shims, such as standard wood shims, can be slid under the sill spacer system 130 for leveling the fenestration unit 100 within the rough opening 10.

With continued reference to FIG. 8, each sill spacer 142 may be positioned in the channel 144 formed on the perimeter 120 on the frame 110. In some embodiments and as illustrated, each sill spacer 142 may be coupled to the frame 110 via an adhesive 146. In other embodiments, the sill spacer(s) 142 may be coupled to the frame 110 in other manners, such as via fasteners. In some embodiments and as illustrated, each sill spacer 142 includes a flat lower contact surface 148. In other embodiments, each sill spacer 142 includes a rounded lower contact surface, and/or any of the features of the sill spacers described in U.S. application Ser. No. 18/478,189, filed Sep. 29, 2023, previously incorporated by reference.

Referring specifically to FIG. 7, the fenestration unit 100 further includes the tether system 132 for securing the unit 100 to the rough opening framing 12. Illustratively, the tether system 132 includes a tether or strap coupled to the sill 118 of the frame 110. The tether system 132 is configured to receive one or more fasteners (not shown) for securing the unit 100 to the rough opening framing 12. In other embodiments, the tether system 132 may additionally or alternatively include tethers or straps coupled to other portions of the frame 110, or the tether system 132 may take other forms. In some embodiments, the tether system 132 may be detached from the frame 110 in the pre-installation configuration. In other embodiments, the tether system 132 may be coupled to the frame 110 in the pre-installation configuration.

### Installation Method for Fenestration Unit 100

Installation of the fenestration unit 100 may proceed in view of the various concepts described in the foregoing sections. In particular, installation of the fenestration unit 100 in the rough opening 10 may begin on the interior side of the rough opening 10 and may be executed by a single installer initially on the interior side of the rough opening 10.

As part of the installation process, the rough opening 10 should be prepared for installation of the fenestration unit 100. Generally, the rough opening 10 is sized to be between ½ inches and ¾ inches larger than the fenestration unit 100 in both width and height, although other setups may also be suitable. Some methods also include forming the rough opening 10, such as by cutting out the rough opening (e.g., plywood cladding covering rough opening framing). The sill portion of the rough opening framing 12 (i.e., the lower framing) may be flashed (e.g., using appropriate flashing tape).

The fenestration unit 100 may then be reconfigured from the pre-installation configuration to the installing configuration. In particular, the retainer 134, the sill spacers 142, and/or the tether system 132 may be coupled to the frame 110 of the unit 100. More specifically, the retainer 134 (FIG. 4) may be coupled to the frame 110 by positioning the claws 147 of one of the coupling feet 141 into one of the slots 149 of the frame 110, and then bending and pivoting the retainer 134 until the toe portion 145 of the other coupling foot 141 is received in the opposite slot 149 on the frame 110.

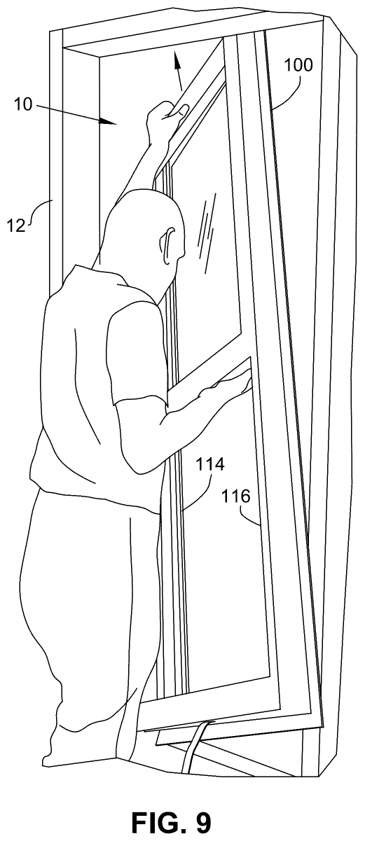

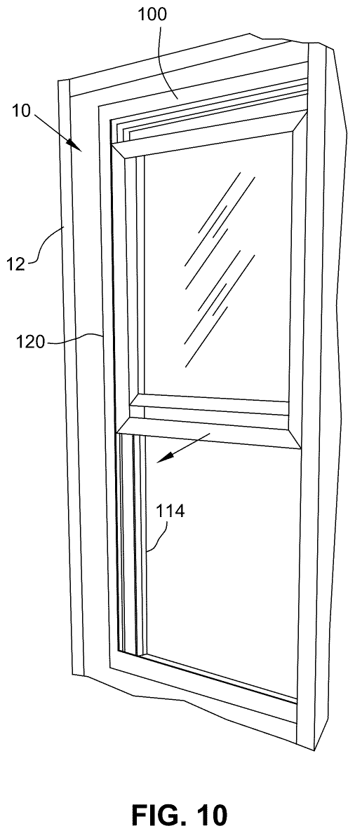

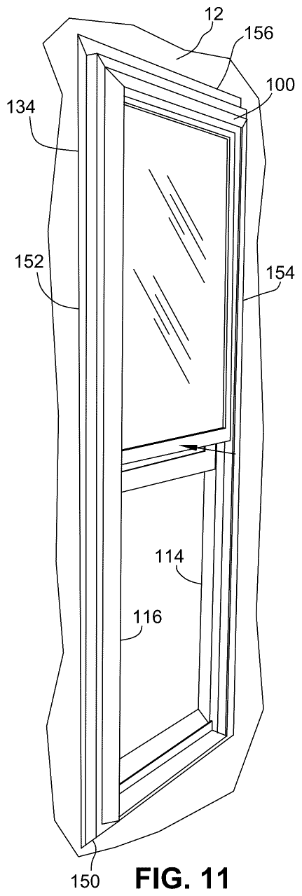

As illustrated in FIG. 9, the fenestration unit 100 is then passed through the rough opening 10 from the interior side to the exterior side, for example by a single installer. As illustrated in FIGS. 10 and 11, the fenestration unit 100 is then moved from the exterior side back toward the interior side (that is, in the insertion direction), for example by the single installer, to seat the fenestration unit 100 in the rough opening 10. In contrast, traditional fenestration installations require at least one installer on the exterior side of a rough opening and/or at least one installer on the interior side of the rough opening.

In some embodiments, the fenestration unit 100 is seated in the rough opening 10 by first inserting a bottom of the fenestration unit 100 into the rough opening 10 and then tilting the top of the fenestration unit 100 toward the interior side such that the installation stabilizer system 128 (FIGS. 1-6) exerts a retention force on the fenestration unit 100 to maintain positive engagement of the fenestration unit 100 with the rough opening framing 12. The installation stabilizer system 128 permits insertion of the fenestration unit 100 within the rough opening 10 in the insertion direction at an insertion force and resist extraction of the fenestration unit from the opening in extraction direction at an extraction force, the extraction force being substantially greater than the insertion force in various examples. From the foregoing, it should also be clear that the method includes inserting the fenestration unit 100 within the rough opening 10 in the insertion direction at a force that meets or exceeds the insertion force.

The fenestration unit 100 is pulled into the rough opening 10 until the installation flange system 134 abuts the exterior surface of the structure surrounding the rough opening 10. The installation flange system 134 acts as an engagement system that is positively engaged with the exterior face and the installation stabilizer system 128 maintains positive engagement of the engagement system with the rough opening framing 12 upon insertion.

The tether system 132 of the fenestration unit 100 is then secured to the rough opening framing 12, for example, by receiving one or more fasteners (not shown).

The fenestration unit 100 is then shimmed, more specifically one or more shims may be slid underneath the sill spacer 142 (FIGS. 7 and 8) on the low side of the unit 100. The fenestration unit 100 is then centered side-to-side in the rough opening 10. The fenestration unit 100 may be centered by inserting a screwdriver having a standard head (e.g., ¼-inch-thick head) and rotating the screwdriver to ensure a minimum desired gap is achieved at the first and second jambs 114, 116 of the frame 110. One or more shims may also be slid between the jambs 114, 116 of the frame 110 and the rough opening framing 12. The fenestration unit 100 is then leveled, more specifically a level is used to check the horizontal level of the fenestration unit 100.

The fenestration unit 100 can then continue to be plumbed, for example, a user may plumb one of the first jamb 114 and the second jamb 116 to vertical level. This operation of adjusting vertical level at the first jamb 114 and/or the second jamb 116 may be carried out using a tool (e.g., a crowbar or prybar) to adjust the plumb of the jambs 114, 116. Additionally or alternatively, the installer may use an air bag designed for such a purpose that can be inflated to adjust the gap between the jambs 114, 116 and the rough opening framing 12, and thus vertical level thereof, or other suitable methods may be implemented as desired.

Referring specifically to FIG. 11, once a desired positioning is achieved, an installer (e.g., the installer previously on the interior side of the rough opening 10, or a different installer) on the exterior side of the rough opening 10 drives fasteners (e.g., screws or nails) through the sill portion 150 of the installation flange system 126 and into the rough opening framing 12.

In some situations, an installer may alternatively level the sill 118 from the interior, proceed to the exterior and secure the sill 118, then plumb and secure the jambs 114, 116 from the exterior.

The installer may apply an air sealant (e.g., spray foam or other air seal material) around the outer perimeter 120 of the fenestration unit 100 in the gap between the rough opening framing 12 and the fenestration unit 100 to create an interior air seal. This interior air seal may be continuous and substantially, or entirely, uninterrupted. Some form of interior air seal typically is necessary for proper water management, as well as proper thermal performance. The positioning of the sill spacer system 130 (FIGS. 7 and 8) helps provide sufficient gap for the air sealant to be deposited in the gap, and also provides a continuous gap around the perimeter 120 of the fenestration unit 100 to ensure a continuous seal can be formed. This sealing operation is typically carried out from an interior side of the rough opening 10. Notably, the sealant may be applied before or after the exterior water barrier steps described below in association with the installation flange system 134.

Forming an exterior water barrier for the installation unit 100 may include using flashing tape or another suitable flashing material to flash over the installation flange system 126. Generally, weather resistant barrier (e.g., Tyvek® home wrap available from DuPont de Nemours, Inc.) will be present on the exterior wall of a building and will be cut with two 45 degree cuts at the rough opening head corners and folded vertically against itself. Once jamb portions 152, 154 and a head portion 156 (FIG. 11) of the installation flange system 126 have been flashed, the weather resistant barrier can be folded back down over the head portion and flashing (e.g., flashing tape) can be applied across the 45 degree cuts at the corners. Flashing (e.g., flashing tape) is not applied to the sill portion 150 of the installation flange system 126 in various examples. This absence of sealing may help ensure that the sill portion 150 acts as a water barrier, but not an air seal. This water-but-non-air barrier configuration promotes equalization of air pressure at a location under the sill and exterior to the rough opening sealant to exterior air pressure. This equalization to exterior air pressure can help prevent water from being forced through the interior air seal (for example, through imperfections in the seal) at the sill during a storm or other high external ambient air pressure event.

### Fenestration Unit 200

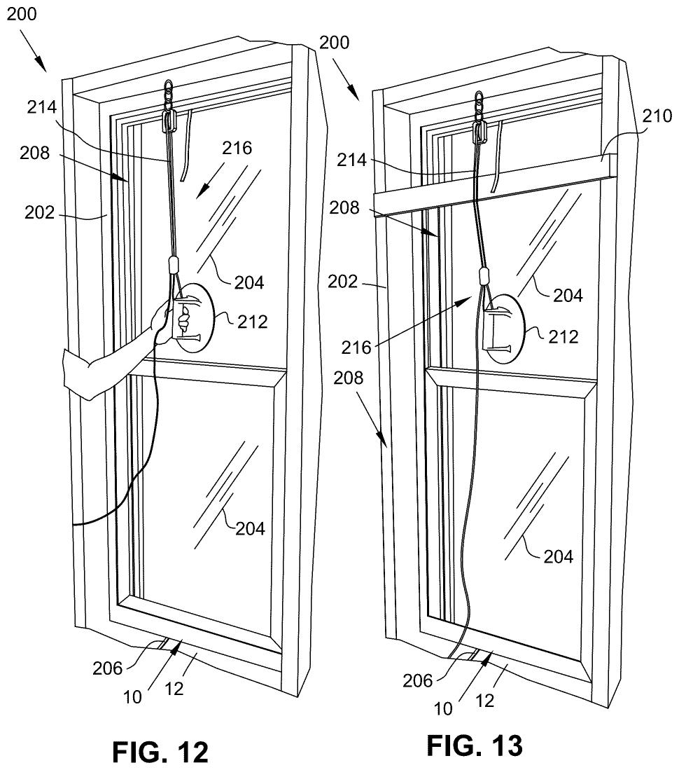

FIGS. 12 and 13 illustrate a fenestration unit 200, according to some embodiments, where both views are side-oriented perspective views from the interior side of a building or wall. FIGS. 12 and 13 illustrate the fenestration unit 200 being installed in a rough opening 10 defined by rough opening framing 12 of the building or wall.

The fenestration unit 200 includes a frame 202 and one or more glazing units 204 that are substantially similar to those of the fenestration unit 100, except for having a larger size. The fenestration unit 200 also includes one or more installation features that facilitate installation of the fenestration unit 200 in the rough opening 10, such as a retention system having an installation stabilizer system (not shown), a sill spacer system (not shown), and a tether system 206. These systems may be substantially similar to the corresponding systems of the fenestration unit 100. Additionally, the fenestration unit 200 includes a hoisting system 208 and an auxiliary retention system 210 (FIG. 12) that facilitate installation of the fenestration unit 200 in the rough opening 10. The hoisting system 208 includes one or more grippers 212 (illustratively, a suction cup) for coupling to the frame 202 (illustratively, via one of the glazing units 204), and a rope 214 couples the gripper 212 to a one-way locking pulley system 216. An installer may pull the rope 214 to lift the fenestration unit 200 relative to the rough opening framing 12, and the installer may then pass the fenestration unit 200 through the rough opening 10 from the interior side to the exterior side. After seating the unit 200 in the rough opening 10 by moving the unit 200 back toward the interior side of the rough opening 10, the auxiliary retention system 210 may be employed to secure the unit 200 to the rough opening framing 12. More specifically, the auxiliary retention system 210 may include one or more cross beams that are positioned between the rope 214 and the rough opening framing 12 to secure the unit 200 to the rough opening framing 12. More specifically, the cross beam takes up slack in the rope 214 to firmly seat the installation flange system (not shown) against the exterior surface of the structure surrounding the rough opening 10. In some cases, this action causes the unit 200 to slightly lift off of the rough opening framing 12. Installation may then continue in substantially the same manner as described in connection with the fenestration unit 100.

### Retainer 300

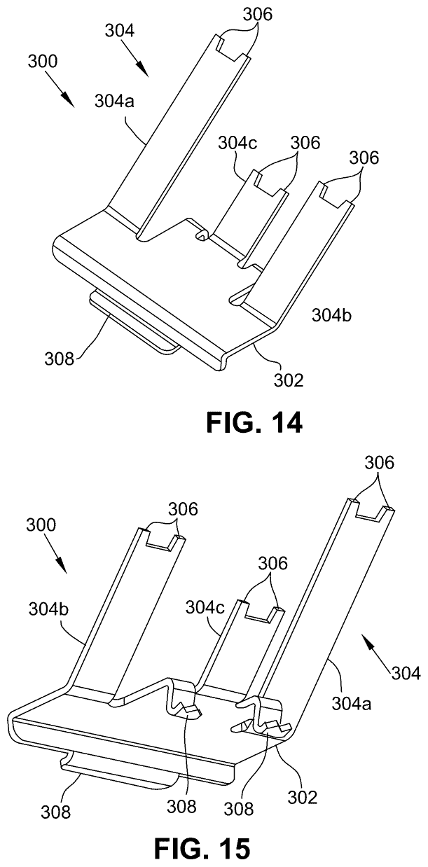

FIGS. 14 and 15 illustrate another retainer 300, also described as stabilizer clips, one or more of which may form part of the installation stabilizer system 128 in addition to or in lieu of the retainer(s) 134 (shown elsewhere). In some embodiments, the retainer 300 may be detached from the frame 110 (shown elsewhere) in the pre-installation configuration. In other embodiments, the retainer 300 may be coupled to the frame 110 in the pre-installation configuration. In some embodiments and as illustrated, the retainer 300 is positioned on the head 112 of the frame 110. In some embodiments, the retainer 300 is positioned on the sill 118 of the frame 110 or one of the jambs 114, 116, or one or more additional retainers 300 are positioned on the sill 118 or one or more of the jambs 114, 116. The retainer 300 may be fabricated by sheet metal stamping and bending processes.

Generally, the retainer 300 is configured to permit insertion of the frame 110 within the rough opening 10 (shown elsewhere) in a first insertion direction and resist extraction of the frame 110 from the rough opening 10 in an extraction direction. The retainer 300 includes a base 302 configured to be secured to the frame 110, and one or more flex arms 304 extending from the base 302. As shown in FIG. 14, each flex arm 304 includes one or more engagement features 306 at a terminal end. In some embodiments and as illustrated, the engagement features 306 are generally rectangular teeth-like structures that are configured to “bite” into the rough opening framing. In some embodiments and as illustrated, one or more of the flex arms 304 may have a different length than other flex arms 304 and/or extend from the base 302 at a different position than the other flex arms 304. For example and as illustrated in FIGS. 14 and 15, the retainer 300 includes a first flex arm 304a extending from a first side of the base 302, a second flex arm 304b extending from a second side of the base 302, and a third flex arm 304c generally disposed between the first flex arm 304a and the second flex arm 304b. In some embodiments and as illustrated, the first flex arm 304a has a first length, the second flex arm 304b has a second length less than the first length, and the third flex arm 304c has a third length less than the second length. In some embodiments, the different lengths of the flex arms 304 advantageously permit fenestration units to be installed in rough openings of various sizes, in particular rough openings that provide different gap sizes between the head of the frame 110 and the rough opening framing. In some embodiments and as illustrated, the third flex arm 304c extends from the base 302 at a position that is horizontally offset from a position on the base 302 from which the first flex arm 304a and the second flex arm 304b extend. In certain embodiments, this arrangement of the flex arms 304a, 304b, and 304c advantageously inhibits the relatively long arms (that is, the first flex arm 304a and the second flex arm 304b) from extending past the interior face of the frame 110 when positioned in the rough opening. In some embodiments and as illustrated, the flex arms 304a, 304b, and 304c extend from the base 302 at the same angle. In some embodiments, the flex arms 304a, 304b, and 304c extend from the base 302 different angles, or are otherwise structured to provide the flex arms 304a, 304b, and 304c with different heights relative to the base 302. Stated another way, in some embodiments the first flex arm 304a has a first height relative to the base 302, the second flex arm 304b has a second height relative to the base 302 less than the first height, and the third flex arm 304c has a third height relative to the base 302 less than the second height.

In certain embodiments and as illustrated, the base 302 includes one or more coupling feet 308 for coupling the base 302 to the frame 110. In some embodiments, the retainer 300 may be coupled to a frame 110 in additional or alternative manners, such as via adhesion or fasteners.

Further aspects of the retainer(s) 300 may be as described in U.S. application Ser. No. 18/478,189, filed Sep. 29, 2023, previously incorporated by reference.

Various advantages may be achieved according to the foregoing example systems and methods. The various examples may be one or more of: more efficient (e.g., cycle time reduced by 50% or more) because one or more retainers hold a unit in a rough opening; simplified training by only involving a single trainer and a single trainee; fenestration units are unable to fall out toward exterior during installation due to presence of retainer(s) and/or hoisting systems; can be installed by a single person from the interior of the building structure; hoisting systems facilitate lifting and passing units through rough openings; interior and exterior installation tasks do not need to be done simultaneously; improved fenestration unit install quality and fenestration unit performance following installation; delivers an installation method that is unique to the industry and offers many benefits for the installer; faster cycle times; separates interior and exterior work so they can be done “independently”.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A fenestration unit configured for installation in a rough opening in a structure defined by rough opening framing, the rough opening having an interior side and an exterior side and the rough opening framing having an interior face and an exterior face opposite the interior face, the fenestration unit comprising:
a frame configured to be moved through the rough opening from the interior side to the exterior side, the frame comprising a perimeter;
an installation fin coupled to the frame, the installation fin projecting outward relative to the perimeter of the frame, and the installation fin configured to abut an exterior surface of the structure surrounding the rough opening upon moving the frame from the exterior side back toward the interior side of the rough opening; and
a retention system coupled to the frame and operable to exert a retention force on the rough opening framing to maintain positive engagement of the fenestration unit with the rough opening framing and resist extraction of the fenestration unit from the rough opening upon moving the frame from the exterior side back toward the interior side of the rough opening such that the fenestration unit remains stationary in the rough opening.

2. The fenestration unit of claim 1, wherein the retention system includes a retainer coupled to the frame, the retainer comprising a plurality of arms configured to contact the rough opening framing to maintain positive engagement of the fenestration unit with the rough opening framing and resist extraction of the fenestration unit from the rough opening.

3. The fenestration unit of claim 2, wherein the plurality of arms includes a first arm, a second arm, and a third arm.

4. The fenestration unit of claim 2, wherein each arm of the plurality of arms comprises an engagement feature at a terminal end.

5. The fenestration unit of claim 1, wherein the retention system includes a retainer, the retainer comprising a plurality of feet configured to couple the retainer to the frame.

6. The fenestration unit of claim 5, wherein the plurality of feet are received in slots formed in the frame to couple the retainer to the frame.

7. The fenestration unit of claim 5, wherein at least one foot of the plurality of feet comprises an ankle portion coupled to an angled toe portion.

8. The fenestration unit of claim 1, wherein the frame further comprises a bottom, and further comprising a sill spacer coupled to the bottom of the frame and configured abut the rough opening framing.

9. The fenestration unit of claim 1, further comprising a strap configured to receive a fastener for securing the fenestration unit to the rough opening framing.

10. A method of installing a fenestration unit in a rough opening in a structure defined by rough opening framing, the rough opening having an interior side and an exterior side, the method comprising:
moving the fenestration unit through the rough opening from the interior side to the exterior side; and
after moving the fenestration unit through the rough opening, moving the fenestration unit from the exterior side toward the interior side to seat a frame of the fenestration unit in the rough opening such that a retention system coupled to the frame of the fenestration unit exerts a retention force on the rough opening framing to retain the frame in the rough opening and inhibit tipping of the frame toward the exterior side of the rough opening.

11. The method of claim 10, wherein the retention system includes a retainer coupled to the frame, the retainer comprising a plurality of arms, and wherein the plurality of arms exert the retention force on the rough opening framing to retain the frame in the rough opening and inhibit tipping of the frame toward the exterior side of the rough opening.

12. The method of claim 11, wherein the plurality of arms includes a first arm, a second arm, and a third arm.

13. The method of claim 11, wherein the plurality of arms includes a first arm having a first length and a second arm having a second length, the second length being less than the first length.

14. The method of claim 10, wherein the retention system includes a retainer, the retainer comprising a plurality of feet coupling the retainer to the frame.

15. The method of claim 10, further comprising, after moving the fenestration unit from the exterior side toward the interior side to seat the frame in the rough opening, securing the fenestration unit to the rough opening framing by installing a fastener through an installation fin coupled to the frame.

16. The method of claim 10, further comprising, after moving the fenestration unit from the exterior side toward the interior side to seat the frame in the rough opening, securing the fenestration unit to the rough opening framing by installing a fastener through a strap coupled to the frame.

17. The method of claim 10, further comprising hoisting the fenestration unit relative to the rough opening by using a hoisting system.

18. The method of claim 17, wherein the hoisting system includes a rope and a pulley system.

19. The method of claim 10, further comprising, before moving the fenestration unit through the rough opening from the interior side to the exterior side, hoisting the fenestration unit relative to the rough opening by using a hoisting system.

20. The method of claim 10, wherein moving the fenestration unit from the exterior side toward the interior side to seat the frame in the rough opening further comprises abutting a sill spacer coupled to a bottom of the frame against the rough opening framing.
